(19) United States
(12) Patent Application Publication
(10) Pub. No.: US 2018/0089767 A1
(43) Pub. Date: Mar. 29, 2018

(54) METHOD AND SYSTEM FOR PREDICTING SERVICE ASSURANCE FOR TASK PROCESSING

(71) Applicant: XEROX CORPORATION, Norwalk, CT (US)

(72) Inventors: Chithralekha Balamurugan, Pondicherry (IN); Karan Kumar Budhraja, New Delhi (IN); Preethi Raj Raajaratnam, Chennai (IN); Shruti Kunde, Mumbai (IN); Madhavi Shankar, Bangalore (IN)

(21) Appl. No.: 15/278,322

(22) Filed: Sep. 28, 2016

(51) Int. Cl. G06Q 50/00; G06Q 10/06

(52) U.S. Cl. CPC G06Q 50/01; G06Q 10/063112

(57) ABSTRACT

The disclosed embodiments illustrate methods and systems for predicting service assurance between requestors and crowd workers for task processing on a crowdsourcing platform. The method includes receiving one or more service level agreement (SLA) attributes of one or more tasks. The method further includes selecting a first set of crowd workers, from a plurality of crowd workers associated with the crowdsourcing platform. The method further includes selecting a second set of crowd workers from one or more SLA-based clusters of the selected first set of crowd workers. The method further includes predicting the service assurance between the requestor and each of the selected second set of crowd workers based on at least performance sustenance parameters associated with the one or more tasks and the selected second set of crowd workers.

### TECHNICAL FIELD

The presently disclosed embodiments are related, in general, to crowdsourcing. More particularly, the presently disclosed embodiments are related to methods and systems for predicting service assurance between requestors and crowd workers for task processing on a crowdsourcing platform.

### BACKGROUND

Currently, organizations outsource process tasks to a committed offshore workforce, via crowdsourcing platforms, to achieve cost optimized process models. Crowdsourcing platforms provide a global opportunity to the offshore workforce, referred to as crowd workers, to work in an open online job market. The crowd workers may connect to the crowdsourcing platforms to select and execute tasks posted on the crowdsourcing platforms by requestors. The crowd sourcing platforms may enable the requesters to leverage the online workforce to process voluminous enterprise tasks on a regular basis. Web services provided by these crowdsourcing platforms may facilitate the requesters to post tasks, retrieve results, and incentivize the crowd workers.

However, the crowdsourcing platforms may not guarantee quality, accuracy, security, confidentiality, and service assurance of the task execution by the crowd workers. Owing to flexible, uncommitted, and discretionary working patterns of the crowd workers, the service assurance for the task execution is considered to be beyond the service assurance offerings of the existing crowdsourcing platforms and therefore, this may further lead to an uncertain situation, at the requestors' end, about whether the service assured for execution of the one or more tasks will be met or not. Therefore, there is a need for a method and a system that can ensure the service assurance for the task execution meeting the other service level agreements (SLAs) of the task.

Further limitations and disadvantages of conventional and traditional approaches will become apparent to a person having ordinary skill in the art, through a comparison of described systems with some aspects of the present disclosure, as set forth in the remainder of the present application and with reference to the drawings.

### SUMMARY

According to embodiments illustrated herein, there is provided a method for predicting service assurance between requestors and crowd workers for task processing on a crowdsourcing platform. The method includes receiving, by one or more transceivers, one or more service level agreement (SLA) attributes of one or more tasks from a requestor-computing device. The method further includes selecting, by the one or more processors, a first set of crowd workers, from a plurality of crowd workers associated with the crowdsourcing platform. The first set of crowd workers are selected based on at least a threshold value associated with each of the received one or more SLA attributes. The method further includes selecting, by the one or more processors, a second set of crowd workers, from one or more SLA-based clusters of the selected first set of crowd workers, based on one or more criteria. The method further includes predicting, by the one or more processors, the service assurance between the requestor and each of the selected second set of crowd workers. The service assurance prediction is based on at least performance sustenance parameters associated with the one or more tasks and the selected second set of crowd workers. The second set of crowd workers corresponds to the crowd workers, who process the one or more tasks on the crowd sourcing platform based on predicted service assurance.

According to embodiments illustrated herein, there is provided a system for predicting service assurance between requestors and crowd workers for task processing on a crowdsourcing platform. The system includes one or more transceivers configured to receive one or more service level agreement (SLA) attributes of one or more tasks from a requestor-computing device. The one or more processors are configured to select a first set of crowd workers, from a plurality of crowd workers associated with the crowdsourcing platform. The first set of crowd workers are selected based on at least a threshold value associated with each of the received one or more SLA attributes. The one or more processors are further configured to select a second set of crowd workers, from one or more SLA-based clusters of the selected first set of crowd workers, based on one or more criteria. The one or more processors are further configured to predict the service assurance between the requestor and each of the selected second set of crowd workers. The service assurance prediction is based on at least performance sustenance parameters associated with the one or more tasks and the selected second set of crowd workers. The second set of crowd workers corresponds to the crowd workers, who process the one or more tasks on the crowd sourcing platform based on predicted service assurance.

According to embodiments illustrated herein, there is provided a computer program product for use with a computer, the computer program product comprising a non-transitory computer readable medium, wherein the non-transitory computer readable medium stores a computer program code for predicting service assurance between requestors and crowd workers for task processing on a crowdsourcing platform. The computer program code is executable by one or more transceivers to receive one or more service level agreement (SLA) attributes of one or more tasks from a requestor-computing device. The computer program code is further executable by one or more processors to select a first set of crowd workers, from a plurality of crowd workers associated with the crowdsourcing platform. The first set of crowd workers are selected based on at least a threshold value associated with each of the received one or more SLA attributes. The computer program code is further executable by one or more processors to select a second set of crowd workers, from one or more SLA-based clusters of the selected first set of crowd workers, based on one or more criteria. The computer program code is further executable by one or more processors to predict the service assurance between the requestor and each of the selected second set of crowd workers. The service assurance prediction is based on at least performance sustenance parameters associated with the one or more tasks and the selected second set of crowd workers. The second set of crowd workers corresponds to the crowd workers, who process the one or more tasks on the crowd sourcing platform based on predicted service assurance.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented, in accordance with at least one embodiment;

FIG. 2 is a block diagram that illustrates a system for predicting service assurance between requestors and crowd workers for task processing on a crowdsourcing platform, in accordance with at least one embodiment;

FIG. 3 is a flowchart that illustrates a method for predicting service assurance between requestors and crowd workers for task processing on a crowdsourcing platform, in accordance with at least one embodiment; and

FIG. 4 is an illustrative system for predicting service assurance between requestors and crowd workers for task processing on a crowdsourcing platform, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a computer, a device (that includes one or more processors/microcontrollers and/or any other electronic components), or a system (that performs one or more operations according to one or more sets of programming instructions, code, or algorithms) associated with an individual. In one example, an individual (e.g., a requestor) may utilize the computing device to transmit one or more tasks and service level agreements (SLAs) of the one or more tasks to a computing server, such as a crowdsourcing platform server. In another exemplary scenario, an individual (e.g., a crowd worker) may utilize the computing device to view and select the one or more tasks on the crowdsourcing platform server. Examples of the computing device may include, but are not limited to, a desktop computer, a laptop, a personal digital assistant (PDA), a mobile device, a smartphone, and a tablet computer (e.g., iPad® and Samsung Galaxy Tab®) and/or the like.

“Crowdsourcing” refers to a distribution of tasks and obtaining needed services by soliciting participation of loosely defined groups of individual crowd workers. A group of crowd workers may include, for example, individuals responding to a solicitation posted on a certain website, such as, but not limited to, Amazon Mechanical Turk®, Crowd Flower®, or Mobile Works®.

A “crowdsourcing platform” refers to a business application, wherein a broad, loosely defined external group of people, a community, or an organization provides solutions as outputs for any specific task processes received by the application as an input. In an embodiment, the business application may be hosted online on a web portal (e.g., crowdsourcing platform servers). Various examples of the crowdsourcing platform include, but are not limited to, Amazon Mechanical Turk® or Crowd Flower® and/or the like.

A “task” refers to a project, a service and/or a job that may be performed by an individual, such as a crowd worker. The task may include instructions about how to perform the task. Further, the task may be associated with one or more attributes. For examples, one or more SLA attributes of a task may include, but are not limited to, a type of the task, a skill set required to process the task, a day of submitting the task, a time in the day of submitting the task, a cost of the task, and so forth.

A “requestor” refers to an individual or an entity, such as an organization or a business group, who may post one or more tasks on a crowdsourcing platform. The requestor may further transmit one or more attributes, such as one or more SLA attributes associated with the one or more tasks. In an embodiment, the requestor may offer an incentive to one or more crowd workers in exchange of processing the one or more tasks.

A “Service Level Agreement (SLA)” refers to a set of terms and conditions in a contract that may be associated with a task posted by a requestor. In an embodiment, the SLA may state expectations agreed upon by a crowd worker or a crowdsourcing platform with the requestor. For example, a SLA associated with a task may correspond to a task completion time, accuracy, a percentage of the task to be completed in a predefined time, an expected quality of the task, and remuneration associated with the task.

A “crowd worker” refers to an individual, who may work upon a task associated with a crowdsourcing platform. The crowd worker may correspond to, but is not limited to, a satellite center employee, a rural business process outsourcing (BPO) firm employee, a home-based employee, or an internet-based employee. In an embodiment, the crowd worker may utilize a computing device to connect to the crowdsourcing platform. In one embodiment, the crowd worker may extract the task from the crowdsourcing platform and thereafter may work upon the extracted task in an offline mode. In another embodiment, the crowd worker may work upon the extracted in an online mode. Hereinafter, the terms “crowd worker,” “crowdworker,” “remote worker,” “worker,” “crowd workforce,” and “crowd” may be used interchangeably.

A “plurality of crowd workers” refers to a set of crowd workers comprising at least two crowd workers, who may have nominated themselves to work upon a task posted by a requestor on a crowdsourcing platform based on at least a first message from a computing server or a computing device.

A “first message” refers to information about a task provided by a requestor prior to uploading of the task on a crowdsourcing platform. The first message may comprise at least a task type, an expected task work, task compensation, an expected task requirement for approval, a task incentive, an expected time of task completion, and an expected time of posting a task.

A “first set of crowd workers” refers to a set of crowd workers, selected from a plurality of crowd workers associated with a crowdsourcing platform, who may work upon a task associated with the crowd sourcing platform. In an embodiment, the selection of the first set of crowd workers from the plurality of crowd workers is based on at least a threshold value associated with each of one or more SLAs of the one or more tasks. For example, an SLA of the task corresponds to a task accuracy of a crowd worker. The threshold value associated the SLA is 90 percent. In such a case, one or more crowd workers in the plurality of crowd workers, who may have the task accuracy equal to or greater than the threshold value, correspond to the first set of crowd workers.

A “second set of crowd workers” refers to a set of crowd workers, selected from a first set of crowd workers associated with a crowdsourcing platform, who may work upon a task associated with the crowd sourcing platform. In an embodiment, the second set of crowd workers is selected from one or more SLA-based clusters of the first set of crowd workers based on one or more criteria. The one or more SLA-based clusters may correspond to an accuracy-based cluster and/or a throughput-based cluster.

“Historical data” of a crowd worker refers to performance data of the crowd worker that is associated with a processing of one or more tasks by the crowd worker over a period of time in the past. For example, the historical data may comprise one or more of, but not limited to, an average execution time of the crowd worker to process a historic task, an average accuracy of the crowd worker on the historic task, an average quality of the crowd worker on the historic task, and an average throughput of the crowd worker on the historic task.

An “incentive” refers to a reward paid to a crowd worker, who may have worked upon one or more tasks on a crowdsourcing platform server. In an embodiment, examples of the incentive may include, but are not limited to, a monetary compensation, lottery tickets, gift items, shopping vouchers, and discount coupons.

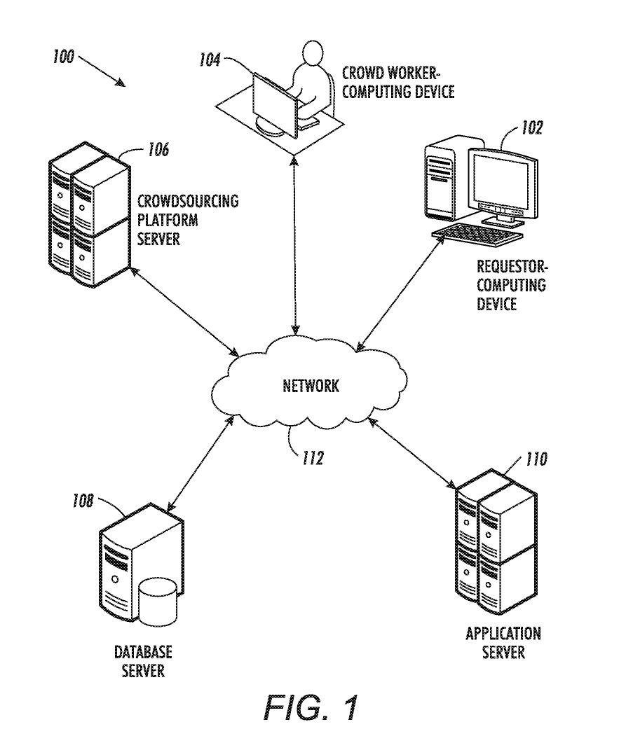

FIG. 1 is a block diagram of a system environment in which various embodiments of a method and a system for predicting service assurance between requestors and crowd workers for task processing on a crowdsourcing platform may be implemented. With reference to FIG. 1, there is shown a system environment 100 that includes a requestor-computing device 102, a crowd worker-computing device 104, a crowdsourcing platform server 106, a database server 108, an application server 110, and a network 112. The requestor-computing device 102, the crowd worker-computing device 104, the crowdsourcing platform server 106, the database server 108, and the application server 110 are communicatively coupled with each other over one or more communication networks, such as a network 112. FIG. 1 shows, for simplicity, one requestor-computing device, such as the requestor-computing device 102, one crowd worker-computing device, such as the crowd worker-computing device 104, one crowdsourcing platform server, such as the crowdsourcing platform server 106, one database server, such as the database server 108, and one application server, such as the application server 110. However, it will be apparent to a person having ordinary skill in the art that the disclosed embodiments may also be implemented using multiple requestor-computing devices, multiple crowd worker-computing devices, multiple crowdsourcing platform servers, multiple database servers, and multiple application servers.

The requestor-computing device 102 may refer to a computing device (associated with a requestor) that may be communicatively coupled to the network 112. The requestor may correspond to an individual, such as an employee associated with an organization, who may utilize the requestor-computing device 102 to transmit the request to the crowd worker-computing device 104, the crowdsourcing platform server 106, the database server 108, and the application server 110 over the network 112. The request may include at least a query related to one or more tasks and one or more attributes associated with the one or more tasks.

The requestor-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the requestor may utilize the requestor-computing device 102 to communicate with the crowd worker-computing device 104, the crowdsourcing platform server 106, the database server 108, and the application server 110 over the network 112.

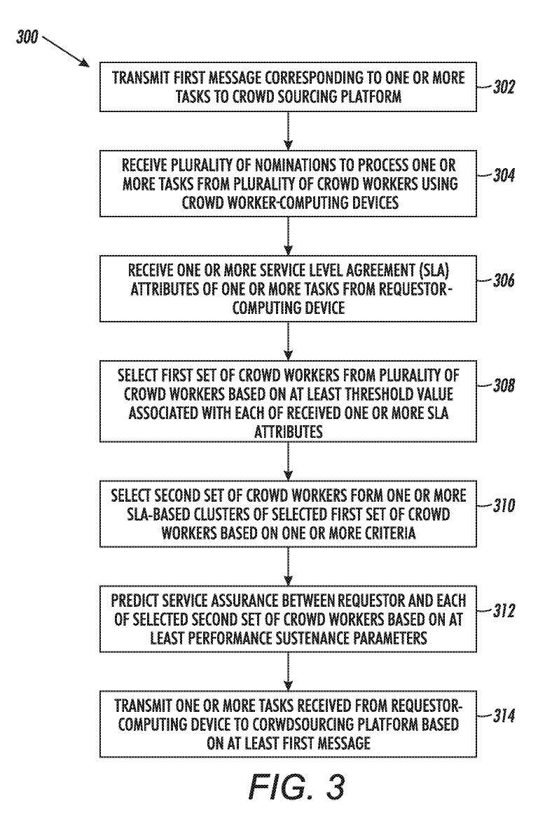

The requestor may further include a display screen that may be configured to display one or more GUIs rendered by the computing server, such as the application server 110. For example, the application server 110 may render a GUI displaying a first set of crowd workers. In an embodiment, the first set of crowd workers may have been selected from one or more crowd workers by the application server 110. An embodiment of the selection of the first set of crowd workers has been explained later in conjunction with FIG. 3. The requestor may further utilize the GUI to select a second set of crowd workers (i.e., the crowd workforce), who may work upon the one or more tasks. An embodiment of the selection of the second set of crowd workers has been explained later in conjunction with FIG. 3.

After selecting the second set of crowd workers, the requestor may utilize the requestor-computing device 102 to communicate/transmit/share the one or more tasks and the associated one or more attributes to the second set of crowd workers over the network 112. Further, in an embodiment, the requestor may receive one or more responses, pertaining to the one or more tasks, from the crowd worker-computing device 104 associated with each of the second set of crowd workers. In an embodiment, the requestor may validate the one or more responses submitted by the second set of crowd workers. After validating, the requestor may initiate payment to the second set of crowd workers based on at least the validation of the one or more responses.

The requestor-computing device 102 may include, but are not limited to, a personal computer, a laptop, a PDA, a mobile device, a tablet, or any other computing devices.

The crowd worker-computing device 104 may refer to a computing device (associated with a crowd-worker) that may be communicatively coupled to the network 112. The crowd worker may correspond to an individual, who may utilize the crowd-worker computing device 104 to select the one or more tasks posted by the requestor on the crowdsourcing platform. The crowd worker may utilize the crowd worker-computing device 104 to connect to the crowdsourcing platform server 106 over the network 112. In another embodiment, the crowd worker may utilize the crowd worker-computing device 104 to receive the one or more tasks transmitted/communicated by the requestor or the crowdsourcing platform server 106 over the network 112. Further, the crowd worker may utilize the crowd worker-computing device 104 to work upon the one or more selected tasks or the one or more received tasks. After processing the one or more tasks, the crowd worker may utilize the crowd worker-computing device 104 to submit the one or more responses of the one or more tasks either to the crowdsourcing platform server 106 or to the requestor-computing device 102 over the network 112. The crowd worker may provide the one or more responses to the one or more tasks using one or more input devices (e.g., keyboard, touch-interface, gesture-recognition, etc.) associated with the crowd worker-computing device 104. In an embodiment, the crowd worker may utilize the crowd worker-computing device 104 to communicate with the requestor over the network 112.

The crowd-worker computing device 104 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the service provider may utilize the crowd-worker computing device 104 to communicate with the requestor-computing device 102, the crowdsourcing platform server 106, the database server 108, and the application server 110, via the network 112.

Examples of the crowd worker-computing device 104 may include, but are not limited to, a laptop, a personal digital assistant (PDA), a tablet computer, a mobile phone, a smartphone, a phablet, or any other computing devices.

The crowdsourcing platform server 106 refers to a computing device that may be configured to host one or more crowdsourcing platforms. In an embodiment, the crowdsourcing platform server 106 may present a graphical user interface (GUI) on a display screen of the requestor-computing device 102 over the network 112, when the requestor logs on the crowdsourcing platform. The requestor may utilize the GUI to post/share the one or more tasks and the associated one or more attributes on to the crowdsourcing platform. The crowdsourcing platform server 106 may receive the one or more tasks posted by the requestor. Thereafter, the crowdsourcing platform server 106 may display the one or more tasks to the one or more crowd workers, who may be connected to the crowdsourcing platform server 106 over the network 112.

In an embodiment, the crowdsourcing platform server 106 may facilitate the one or more crowd workers to select and/or download and thereafter, work upon the one or more tasks. Further, in an embodiment, the crowdsourcing platform server 106 may receive the one or more responses pertaining to the one or more tasks from the one or more crowd workers over the network 112.

In an embodiment, the crowdsourcing platform server 106 may facilitate a direct communication between the requestor and the one or more crowd workers over the network 112. In an embodiment, the crowdsourcing platform server 106 may facilitate the direct communication to allow the requestor and the one or more crowd workers to negotiate terms and conditions of the Service Level Agreement (SLA) associated with the one or more tasks.

The crowdsourcing platform server 106 may be realized through various types of application servers, such as, but not limited to, Java application server, .NET framework, and Base4 application server.

The database server 108 may refer to a computing device or a storage device that may be communicatively coupled to the network 112. In an embodiment, the database server 108 may be configured to perform one or more database operations. Examples of the one or more database operations may include receiving/transmitting one or more queries, requests, one or more tasks, or historical data of crowd workers from/to one or more computing devices, such as the requestor-computing device 102, the crowd-worker computing device 104, the crowdsourcing platform server 106, the database server 108, or the application server 110. The one or more database operations may further include processing and storing the one or more queries, requests, one or more tasks, or historical data of crowd workers. The database server 108 may be configured to store the one or more attributes associated with the one or more tasks. In an embodiment, the database server 108 may be configured to store historical data associated with each of the one or more crowd workers. The historical data of a crowd worker may comprise one or more performance characteristics associated with the crowd worker. For example, one or more performance characteristics of a crowd worker may include one or more of, but are not limited to, a qualification of the crowd worker, a skill set associated with the crowd worker, a count of tasks completed by the crowd worker in the past, an average time taken by the crowd worker to complete each of the count of tasks, and a quality of work associated with each of the count of tasks. Further, the one or more performance characteristics of the crowd worker may include an availability of the crowd worker on a particular day, a count of sessions associated with the crowd worker on the particular day, a set of demographical attributes (e.g., name, age, location, acquaintance with other crowd workers, and/or the like) associated with the crowd worker, and a remuneration charged for each of the count of tasks by the crowd worker. In an embodiment, the database server 108 may be configured to obtain the one or more performance characteristics pertaining to the crowd worker from various sources, such as, but not limited to, social networking websites, databases of various organizations that may provide a rightful authentication to access information pertaining to the crowd worker, and the crowdsourcing platform. Further, in an embodiment, the database server 108 may be configured to store the one or more responses, pertaining to the one or more tasks, submitted by the one or more crowd workers.

Further, in an embodiment, the database server 108 may store one or more sets of instructions, code, scripts, or programs that may be retrieved by the application server 110 to perform the one or more operations. For querying the database server 108, one or more querying languages may be utilized, such as, but not limited to, SQL, QUEL, and DMX. In an embodiment, the database server 108 may be realized through various technologies, such as, but not limited to, Microsoft® SQL Server, Oracle®, IBM DB2®, Microsoft Access®, PostgreSQL®, MySQL® and SQLite®, MongoDB®, and/or the like.

A person having ordinary skill in the art will understand that the scope of the disclosure is not limited to the database server 108 as a separate entity. In an embodiment, the functionalities of the database server 108 may be integrated into the crowdsourcing platform server 106, or the application server 110 and vice-versa, without deviating from the scope of the disclosure.

The application server 110 may refer to a computing device or a software framework hosting an application or a software service that may be communicatively coupled to the network 112. In an embodiment, the application server 110 may be implemented to execute procedures, such as, but not limited to, the one or more sets of programs, instructions, code, routines, or scripts stored in one or more memory units for supporting the hosted application or the software service. In an embodiment, the hosted application or the software service may be configured to perform the one or more operations of the application server 110.

In an embodiment, the requestor may utilize the requestor-computing device 102 to access/connect the application server 110 to upload the one or more tasks and the associated one or more SLA attributes. In an embodiment, the application server 110 may further upload the one or more tasks to the crowdsourcing platform server 106. In an embodiment, the application server 110 may act as a middleware for the requestor-computing device 102 to upload the one or more tasks. In an embodiment, the application server 110 may include an application interface or a plugin of the crowdsourcing platform server 106 that may enable the application server 110 to upload the one or more tasks to the crowdsourcing platform server 106. Further, the application interface or the plugin may further enable the access to the information pertaining to the one or more crowd workers registered on the crowdsourcing platform server 106.

In an embodiment, the application server 110 may present a web interface on the requestor-computing device 102 that may enable the requestor to transmit a first message to the crowd sourcing platform over a communication network, such as the network 112. In an embodiment, the message may further correspond to definition of one or more attributes pertaining to the task. Examples of the one or more attributes may comprise, but are not limited to, at least a task type, an expected task work, task compensation, an expected task requirement for approval, a task incentive, an expected time of task completion, and an expected time of posting a task.

In an embodiment, the application server 110 may present a web interface on the requestor-computing device 102 that may enable the requestor to submit the one or more tasks and the associated one or more SLA attributes, such as accuracy, an execution time, and a throughput, that are required to process the one or more tasks. Further, the web interface in an embodiment, the application server 110 may receive a plurality of nominations, to process the one or more tasks, from at least a plurality of crowd worker-computing devices associated with the plurality of crowd workers.

Further, in an embodiment, the application server 110 may determine the threshold value pertaining to the execution time based on at least a mean, a standard deviation, and a count of crowd workers in the plurality of crowd workers. Further, in an embodiment, the application server 110 may determine the mean and the standard deviation based on at least historical execution time of each of the plurality of crowd workers. Thereafter, the application server 110 may determine the threshold value pertaining to the throughput based on at least the mean, the standard deviation, and the count of crowd workers in the plurality of crowd workers. Further, in an embodiment, the application server 110 may determine the mean and the standard deviation based on at least historical throughput of each of the plurality of crowd workers.

Further, in an embodiment, the application server 110 may be configured to determine an average value of the one or more SLA attributes, for the selected first set of crowd workers based on at least a historical performance of the selected first set of crowd workers. After determining the average value of the one or more SLA attributes, the application server 110 may be further configured to cluster the selected first set of crowd workers based on the determined average value of the one or more SLA attributes. The clustering of the first set of crowd workers has been explained later in conjunction with FIG. 3.

After selecting the first set of crowd workers, the application server 110 may be configured to determine a second set of crowd workers. In an embodiment, the second set of crowd workers are selected from the clustered first set of crowd workers based on at least the one or more attributes provided by the requestor. The selection of the second set of crowd workers has been explained later in conjunction with FIG. 3.

After selecting the second set of crowd workers, the application server 110 may predict service assurance between the requestor and each of the selected second set of crowd workers. The application server 110 may further enable the requestor to select the second set of crowd workers from the first set of crowd workers. The application server 110 may utilize the performance sustenance parameters associated with the one or more tasks and the selected second set of crowd workers to predict the service assurance. The performance sustenance parameters may include, but not limited to, an incentive associated with the one or more tasks, a pre-defined tolerance value pertaining to a deviation in quality, and a performance discipline of each of the selected second set of crowd workers during the processing of the one or more tasks on the crowdsourcing platform.

Further, after predicting the service assurance by selected second set of crowd workers, the requestor may communicate/transmit the one or more tasks to the second set of crowd workers. Further, the requestor may receive the one or more responses of the one or more tasks from the crowd worker-computing device 104 associated with each of the second set of crowd workers over the network 112.

The application server 110 may be realized through various types of application servers, such as, but not limited to, a Java application server, a .NET framework application server, a Base4 application server, a PHP framework application server, or any other application server framework.

A person having ordinary skill in the art will understand that the scope of the disclosure is not limited to the crowdsourcing platform server 106, the database server 108 or the application server 110 as separate entities. In an embodiment, the functionalities of the crowdsourcing platform server 106, the database server 108, or the application server 110 may be combined into a single server, without limiting the scope of the disclosure.

The network 112 corresponds to a medium through which devices, such as the requestor-computing device 102, the crowd worker-computing device 104, the crowdsourcing platform server 106, and the database server 108, may communicate with each other. Examples of the network 112 may include, but are not limited to, the Internet, a cloud network, a Wireless Fidelity (Wi-Fi) network, a Wireless Local Area Network (WLAN), a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), and/or a Metropolitan Area Network (MAN). Various devices in the system environment 100 may be configured to connect to the network 112, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

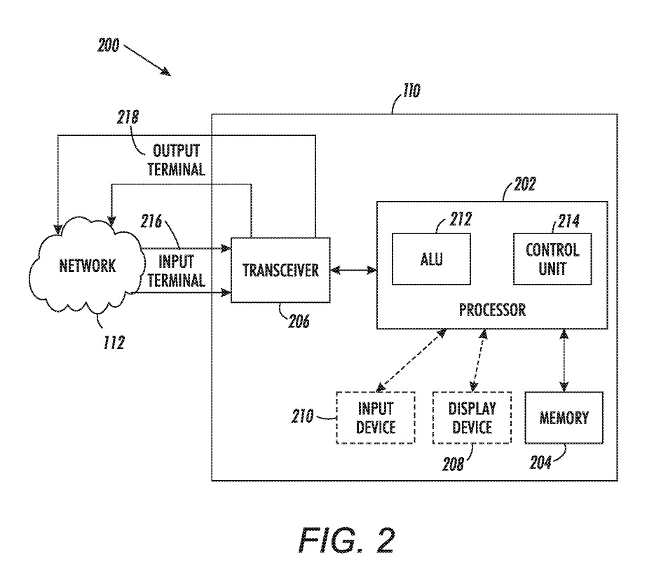

FIG. 2 is a block diagram that illustrates a system for selecting the crowd workforce for processing the one or more tasks, in accordance with at least one embodiment. With reference to FIG. 2, there is shown a system 200 that may include one or more processors, such as a processor 202, one or more memories, such as a memory 204, one or more transceivers, such as a transceiver 206, and one or more input/output (I/O) units, such as an I/O unit 208.

The system 200 may correspond to a computing device, such as the requestor-computing device 102, the crowd-worker computing device 104, the crowdsourcing platform server 106, or the application server 110, without departing from the scope of the disclosure. However, for the purpose of the ongoing description, the system 200 corresponds to the application server 110.

The processor 202 comprises suitable logic, circuitry, interfaces, and/or code that may be configured to execute one or more sets of instructions, programs, or algorithms stored in the memory 204 to perform the one or more operations. For example, the processor 202 may be configured to select a first set of crowd workers from a plurality of crowd workers associated with the crowdsourcing platform. In an embodiment, the processor 202 may be configured to select a second set of crowd workers from one or more SLA based clusters of the selected first set of crowd workers. In an embodiment, the processor 202 may be configured to predict the service assurance between the requestor and each of the selected second set of crowd workers. In an embodiment, the processor 202 may be communicatively coupled to the memory 204, the transceiver 206, and the I/O unit 208. The processor 202 may comprise an arithmetic logic unit (ALU) 212 and a control unit 214. The processor 202 may be implemented based on a number of processor technologies known in the art. Examples of the processor 202 may include, but not limited to, an X86-based processor, a Reduced Instruction Set Computing (RISC) processor, an Application-Specific Integrated Circuit (ASIC) processor, and a Complex Instruction Set Computing (CISC) processor.

The memory 204 may be operable to store machine code and/or computer programs having at least one code section executable by the processor 202, the I/O unit 210, and/or the transceiver 206. The memory 204 may store one or more sets of instructions, programs, code, or algorithms that are executed by the processor 202, the I/O unit 210, and/or the transceiver 206 to perform the respective one or more operations. Some of the commonly known memory implementations include, but are not limited to, a random access memory (RAM), a read-only memory (ROM), a hard disk drive (HDD), and a secure digital (SD) card. In an embodiment, the memory 204 may include machine code and/or computer programs that are executable by the processor 202, the transceiver 206, and/or the I/O unit 208 to perform the one or more specific operations. It will be apparent to a person having ordinary skill in the art that the one or more instructions stored in the memory 204 enables the hardware of the system 200 to perform the one or more operations.

The transceiver 206 comprises suitable logic, circuitry, interfaces, and/or code that may be configured to receive/transmit the one or more queries, requests, one or more tasks, historical data of crowd workers or other information from/to one or more computing devices (such as the requestor-computing device 102 and the crowd worker-computing device 104) and/or one or more servers (such as the crowdsourcing platform server 106 and the database server 108) over the network 112. The transceiver 206 may implement one or more known technologies to support wired or wireless communication with the network 112 through an input terminal 216 and an output terminal 218. In an embodiment, the transceiver 206 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O unit 208 comprises suitable logic, circuitry, interfaces, and/or code that may be operable to facilitate the individual, such as the service provider or the requestor, to input one or more pre-defined parameters or constraints. For example, the requestor may utilize the I/O unit 208 to input the request for processing the one or more tasks. The I/O unit 208 may be operable to communicate with the processor 202, the memory 204, and/or the transceiver 206. Further, in an embodiment, the I/O unit 208, in conjunction with the processor 202 and the transceiver 206 may be operable to provide one or more responses (e.g., the one or more selected second set of crowd workers who may process the one or more tasks). Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

FIG. 3 is a flowchart that illustrates a method for predicting service assurance between requestors and crowd workers for task processing on a crowdsourcing platform, in accordance with at least one embodiment. With reference to FIG. 3, there is shown a flowchart 300 that has been described in conjunction with FIG. 1 and FIG. 2.

At step 302, the first message corresponding to the one or more tasks is transmitted to the crowd sourcing platform server 106. In an embodiment, the processor 202, in conjunction with the transceiver 206, may be configured to transmit the first message corresponding to the one or more tasks to the crowd sourcing platform server 106. In an embodiment, the first message may comprise information about the one or more tasks, for example, the task type, the expected task work, the task compensation, the expected task requirement for approval, the task incentive, the expected time of task completion, and the expected time of posting a task. In an exemplary scenario, the task type may correspond to an image processing task or a text processing task in an analog form and/or a digital form retained in at least one of an electronic form or a printed form. Each of the electronic form or the printed form may include one or more images, symbols, text, line art, blank, or non-printed regions etc. In an embodiment, the electronic data may be obtained by scanning a corresponding printed document containing the electronic data. Further, the electronic data may be stored in various file formats, such as JPG or JPEG, GIF, TIFF, PNG, BMP, RAW, PSD, PSP, PDF, and the like. In an embodiment, the one or more tasks may correspond to one or more of, but are not limited to, data translation, data transcription, image tagging, article writing, website testing, data verification, logo design, business card design, advertisement, video, image tagging, and website design.

Prior to the transmission of the first message, the processor 202, in conjunction with the transceiver 206, may receive the first message corresponding to the one or more tasks from the requestor-computing device 102 over the network 112. In an embodiment, the requestor associated with the requestor-computing device 102 may define information in the first message. For example, the requestor may define a type or a sub-type of the one or more tasks. Further, the requestor may define the work of the one or more tasks that the crowd worker may have to do in order to process the one or more tasks. Further, the requestor may define the incentive plan for processing the one or more tasks. Further, the requestor may define the expected requirements, in terms of execution time, quality, accuracy, and/or the like, of the one or more crowd workers. The fulfillment of the expected requirements may be required for an approval of the one or more tasks. The requestor may further define bonus details, if any, for processing the one or more tasks. Further, the requestor may define the time (or a time period) at (during) which the one or more tasks may be posted or uploaded over the crowdsourcing platform server 106. After defining the information about the one or more tasks, the requestor may utilize the requestor-computing device 102 to transmit the first message corresponding to the one or more tasks to the processor 202. The processor 202, in conjunction with the transceiver 206, may receive the first message corresponding to the one or more tasks. Further, the processor 202, in conjunction with the transceiver 206, may store the received first message in a storage device, such as the memory 204 or the database server 108.

Further, in an embodiment, the processor 202, in conjunction with the transceiver 206, may retrieve the received first message from the storage device. Thereafter, the processor 202, in conjunction with the transceiver 206, may transmit the received first message corresponding to the one or more tasks to the crowdsourcing platform server 1063 over the network 112. Thereafter, the one or more crowd workers may log-in to their respective account on the crowdsourcing platform server 106 to view the first message corresponding to the one or more tasks. In another embodiment, the processor 202, in conjunction with the transceiver 206, may transmit the received first message corresponding to the one or more tasks to the one or more crowd workers, who are associated with the crowdsourcing platform server 106. For example, the processor 202, in conjunction with the transceiver 206, may transmit the received first message as a text message or an Email attachment to the one or more crowd worker-computing devices, such as the crowd worker-computing device 104, over the network 112. The processor 202 may utilize a contact number (e.g., a phone number) or an Email-id of each of the one or more crowd workers, extracted from the crowdsourcing platform server 106 or the database server 108, to transmit the received first message as a text message or an Email attachment.

At step 304, the plurality of nominations to process or work upon the one or more tasks is received from a plurality of crowd worker-computing devices associated with the plurality of crowd workers. In an embodiment, the processor 202, in conjunction with the transceiver 206, may be configured to receive the plurality of nominations to process or work upon the one or more tasks from the plurality of crowd worker-computing devices associated with the plurality of crowd workers over the network 112. In an embodiment, the processor 202, in conjunction with the transceiver 206, may receive the plurality of nominations from the plurality of crowd worker-computing devices, via the crowdsourcing platform server 106, over the network 112.

Prior to the receiving of the plurality of nominations from the plurality of crowd worker-computing devices, the one or more crowd workers associated with the crowdsourcing platform server 106 may view the received first message corresponding to the one or more tasks. Based on the information in the received first message, the plurality of crowd workers that corresponds to the one or more crowd workers may utilize the plurality of crowd worker-computing devices to transmit the plurality of nominations to the crowdsourcing platform server 106 or the transceiver 206 over the network 112. In an embodiment, the plurality of nominations may be representative of an acceptance of each of the plurality of crowd workers to process or work upon the one or more tasks. After receiving the plurality of nominations from the plurality of crowd workers, the processor 202, in conjunction with the transceiver 206, may store the received plurality of nominations in the storage device, such as the memory 204 or the database server 108. Further, in an embodiment, the processor 202, in conjunction with the transceiver 206, may transmit the plurality of nominations to the requestor-computing device 102 over the network 112.

At step 306, the one or more SLA attributes of the one or more tasks are received from the requestor-computing device 102. The one or more SLA attributes of the one or more tasks may comprise at least one or more of, but are not limited to, the accuracy, the execution time, and the throughput of the one or more tasks. In an embodiment, the processor 202, in conjunction with the transceiver 206, may further be configured to receive the one or more SLA attributes of the one or more tasks from the requestor-computing device 102 over the network 112. In an embodiment, the requestor may transmit the one or more SLA attributes of the one or more tasks to the transceiver 206 based on the received plurality of nominations.

Further, in an embodiment, the requestor may transmit the threshold value associated with one or more of the one or more SLA attributes to the transceiver 206. The threshold value may correspond to a limiting factor (i.e., an upper limitation, a lower limitation, or both) associated with the one or more SLA attributes. The fulfillment of the threshold value may be essential in the processing of the one or more tasks.

In a scenario where the requestor has not provided the threshold value of one or more of the one or more SLA attributes, the processor 202 may be configured to determine the threshold value (i.e., an upper limitation, a lower limitation, or both) of the one or more of the one or more SLA attributes. The processor 202 may determine the threshold value of the one or more of the one or more SLA attributes based on at least the historical data of each of the plurality of crowd workers. Prior to the determining of the threshold value, the processor 202 may be configured to extract the historical data of the plurality of crowd workers from the database server 108 or the crowdsourcing platform server 106. The historical data of each crowd worker may comprise one or more demographic attributes and one or more performance characteristics. For example, the one or more demographic attributes may comprise one or more of, but are not limited to, a name, an age, a qualification, and a skill set. The one or more performance characteristics may comprise one or more of, but are not limited to, a log of tasks completed in the past and the execution time, accuracy, quality, and throughput associated with each processed task in the log of tasks. The historical data may further comprise an availability of the crowd worker on a particular day, a count of sessions on the particular day, and remuneration associated with the crowd worker.

After extracting the historical data, the processor 202 may determine the threshold value based on at least the extracted historical data. In an embodiment, the processor 202 may determine the threshold value pertaining to the accuracy of the one or more tasks based on at least the mean, the standard deviation, and the count of crowd workers in the plurality of crowd workers. Further, the mean and the standard deviation are determined based on at least the historical accuracy of each of the plurality of crowd workers. Further, in an embodiment, the processor 202 may determine the threshold value pertaining to the execution time of the one or more tasks based on at least the mean, the standard deviation, and the count of crowd workers in the plurality of crowd workers. Further, the mean and the standard deviation are determined based on at least the historical execution time of each of the plurality of crowd workers. Further, in an embodiment, the processor 202 may determine the threshold value pertaining to the throughput based on at least the mean, the standard deviation, and the count of crowd workers in the plurality of crowd workers. Further, the mean and the standard deviation are determined based on at least the historical throughput associated with the plurality of crowd workers.

In an exemplary scenario, the processor 202 may utilize the following equation (denoted by equation-1) to determine the threshold value of the one or more of the one or more SLA attributes:

threshold value (upper, lower)=μ±(1.96*σ/n) (1)

where,
μ: correspond to mean;
σ: correspond to standard deviation; and
n: correspond to a count of crowd workers in the plurality of crowd workers.

At step 308, the first set of crowd workers is selected from the plurality of crowd workers based on at least the threshold value associated with each of the received one or more SLA attributes. In an embodiment, the processor 202 may be configured to select the first set of crowd workers from the plurality of crowd workers based on at least the threshold value associated with each of the received one or more SLA attributes. In an embodiment, the threshold value of each of the one or more SLA attributes is either received from the requestor-computing device 102 or is determined by the processor 202, as discussed above in step 306.

Prior to the selection of the first set of crowd workers from the plurality of crowd workers, the processor 202 may further be configured to determine one or more historical attributes (e.g., the historical accuracy, the historical execution time, and the historical throughput) of each of the plurality of crowd workers. In an embodiment, the processor 202 may determine the historical accuracy, the historical execution time, and the historical throughput based on the historical data. In an embodiment, the historical accuracy of a crowd worker may be determined based on accuracies (e.g., average of accuracies) on tasks that had been processed by the crowd worker in the past or during a pre-defined time duration. In an embodiment, the historical execution time of the crowd worker may be determined based on time taken (e.g., average of time taken) by the crowd worker to process or execute the tasks in the past or during the pre-defined time duration. In an embodiment, the historical throughput (e.g., average of throughput) of the crowd worker may be determined based on throughput of the crowd worker on the tasks processed by the crowd worker in the past or during the pre-defined time duration.

Thereafter, in an embodiment, the processor 202 may select the first set of crowd workers from the plurality of crowd workers based on the threshold value associated with the one or more SLA attributes and the one or more historical attributes of the plurality of crowd workers. Based on preferences specified by the requestor, the processor 202 may select one or more of the attributes (SLA and historical) for selecting the first set of crowd workers from the plurality of crowd workers. For example, if the requestor specifies to select the first set of crowd workers based on only accuracy, then the processor 202 may select the first set of crowd workers from the plurality of crowd workers, such that the historical accuracy of each of the first set of crowd workers is equal to or greater than the threshold value associated with the SLA “accuracy.” Similarly, if the requestor specifies to select the first set of crowd workers based on the accuracy, execution time, and throughput, then the processor 202 may select the first set of crowd workers from the plurality of crowd workers considering each of the accuracy, execution time, and throughput. In such scenario, the historical accuracy of each of the first set of crowd workers is equal to or greater than the threshold value associated with the SLA “accuracy.” Similarly, in such scenario, the historical execution time of each of the first set of crowd workers is equal to or less than the threshold value associated with the SLA “execution time.” Similarly, in such scenario, the historical throughput of each of the first set of crowd workers is equal to or greater than the threshold value associated with the SLA “throughput.”

At step 310, the second set of crowd workers is selected from the one or more SLA-based clusters of the selected first set of crowd workers. In an embodiment, the processor 202 may further be configured to select the second set of crowd workers from the one or more SLA-based clusters of the selected first set of crowd workers. In an embodiment, the processor 202 may select the second set of crowd workers from the one or more SLA-based clusters of the selected first set of crowd workers based on the one or more criteria.

In an embodiment, the processor 202 may select the top crowd workers, based on their average accuracy, amongst the first set of crowd workers to select the second set of crowd workers. Further, the processor 202 may upscale the required throughput of the one or more task, so as to select the second set of crowd workers. For example, for a throughput requirement of “500 HITS,” the throughput was scaled to “1000 HITS” and “55 workers” were selected from the “112 workers” based on clustering workers by average accuracy (and ranking workers by accuracy within the cluster) and selecting the one or more crowd workers to meet the scaled throughput.

At step 312, the service assurance between the requestor and each of the selected second set of crowd workers is predicted based on at least the performance sustenance parameters. In an embodiment, the processor 202 may predict the service assurance between the requestor and each of the selected second set of crowd workers based on at least the performance sustenance parameters. The performance sustenance parameters are associated with the one or more tasks and the selected second set of crowd workers to predict the service assurance. The performance sustenance parameters may include, but not limited to, an incentive associated with the one or more tasks, a pre-defined tolerance value pertaining to a deviation in quality, and a performance discipline of each of the selected second set of crowd workers during the processing of the one or more tasks on the crowdsourcing platform.

In an embodiment, the processor 202 may determine the performance of each of the selected crowd worker. Further, the requestor in the request may define that the performance criteria of the crowd workers, who have surpassed the pre-defined performance criteria, may be awarded with the incentive associated with the one or more tasks.

In an embodiment, the processor 202 may determine a tolerance value for negative deviation in quality for the task performed by the second set of crowd workers. The tolerance in deviation is set at μ−σ/2. Since a worker's accuracy cannot always be maintained at the expected accuracy, the processor 202 may determine a buffer until which the negative deviation in accuracy may be tolerated. If in a particular day, a worker's average accuracy on all the HITS deviates below the tolerated accuracy, then he may be disqualified from working on further HITS.

In an embodiment, the processor 202 may determine the performance discipline of each of the selected second set of crowd workers during the processing of the one or more tasks on the crowdsourcing platform. Further, in a scenario, where the selected crowd worker does not execute the task as per the request, then the selected crowd worker may be disqualified from executing the assigned task.

At step 314, the one or more tasks, received from the requestor-computing device 102, are transmitted to the crowdsourcing platform server 106 based on at least the first message. In an embodiment, the processor 202, in conjunction with the transceiver 206, may further be configured to transmit the one or more tasks, received from the requestor-computing device 102, to the crowdsourcing platform server 106 based on at least the first message.

In an embodiment, the processor 202 may select the second set of crowd workers, the requestor may communicate with the selected second set of crowd workers over the network 112. Further, the requestor may transmit or share the one or more tasks with the selected second set of crowd workers. Each of the second set of crowd workers may utilize the crowd worker-computing device 104 to work upon the one or more tasks. After completing the one or more tasks, the second set of crowd workers may submit the one or more responses corresponding to the one or more tasks to the requestor over the network 112. The requestor may validate the one or more responses received from the second set of crowd workers.

In an exemplary scenario, there are “100 crowd workers.” A requestor posts a task. As per requirements of the requestor, the crowd workers should be available on “Friday” (high priority). Further, the crowd workers should possess image processing skill (low priority). Further, a cost associated with each of the crowd workers should be at most “USD 15” (medium priority). Thereafter, the processor 202 may check for the crowd workers (among the “100 crowd workers”), who may be available on “Friday.” Out of “100 crowd workers,” “75 crowd workers” are available on “Friday.” In such a case, the processor 202 may filter out “25 crowd workers,” who are not available on “Friday.” Thereafter, the processor 202 may check for the crowd workers (among the “75 crowd workers”), who may charge less or equal to “USD 15.” Out of “75 crowd workers,” “45 crowd workers” charge less than or equal to “USD 15.” In such a case, the processor 202 may filter out “30 crowd workers,” who charges more than “USD 15” for processing the task. Thereafter, the processor 202 may check for the crowd workers (among “45 crowd workers”), who may possess the image processing skill. Out of “45 crowd workers,” “15 crowd workers” possess the image processing skill. In such a case, the processor 202 may filter out “30 crowd workers,” who may not possess the image processing skill. Thus, a first set of crowd workers may comprise “15 crowd workers,” who may be eligible to work upon the task according to the requirements of the requestor.

In another exemplary scenario, a graphical user-interface (GUI) may be utilized by the requestor to initiate the selection of the crowd workforce for processing the one or more tasks, in accordance with at least one embodiment. The GUI may be displayed on a display screen of a computing device, such as the requestor-computing device 102. The requestor may log into a crowdsourcing platform using his/her user id and password. The processor 202 may present the GUI on the requestor-computing device 102, when the user may have logged in. The requestor may click on a tab, such as upload task tab, to upload or post the one or more tasks. Further, the requestor may click on a tab, such as input attributes of task tab, to upload the one or more attributes associated with the one or more tasks. Thereafter, the requestor may click on a tab, such as select crowd workforce tab, to select the second set of crowd workers from the first set of crowd workers.

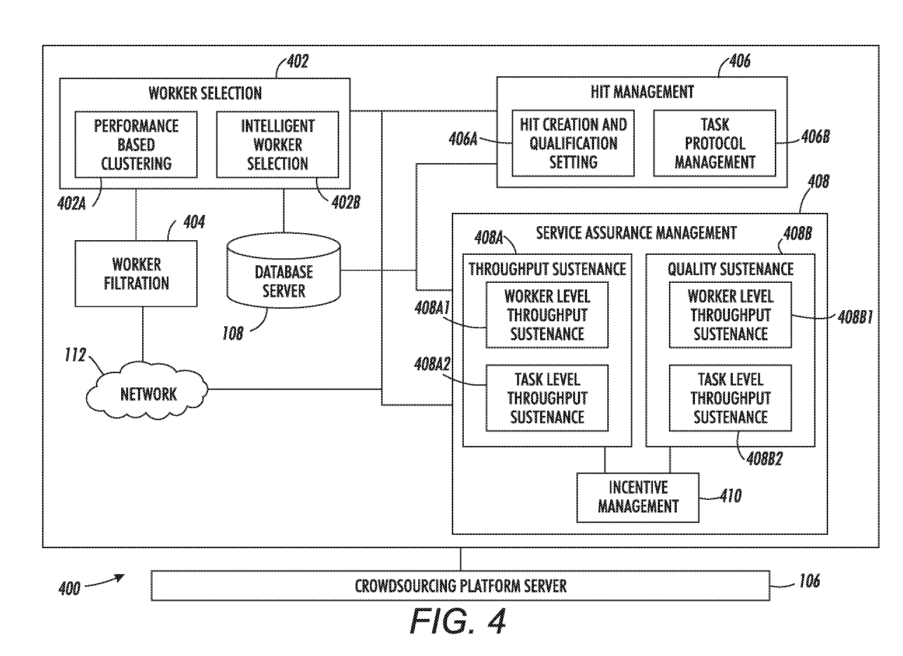

FIG. 4 is an illustrative system for predicting service assurance between requestors and crowd workers for task processing on a crowdsourcing platform, in accordance with at least one embodiment. With reference to FIG. 4, there is shown an exemplary system 400 that has been explained in conjunction with FIGS. 1-3.

The system environment 400 may include the database server 108 which stores the historical data of worker performance data captured from the crowdsourcing platform. The system environment 400 may further include a worker selection module 402 which uses accuracy and throughput clustering to select the best workers among the filtered workers to perform the requester's task. The worker selection module 402 may further include sub-modules, such as a performance based clustering module 402A and an intelligent worker selection module 402B. The system environment 400 may further include a worker filtration module 404 that uses the historical data to filter the crowd workers who exhibit requester required service assurance fulfillment possibilities. The system environment 400 may further include a HIT management module 406, comprising a HIT creation and qualification setting 406A and a task protocol management 4066, is focused on HIT creation with the required level of granularity as is appropriate for the filtered/selected workers during the process of worker seasoning and actual task execution respectively. Further, it also sets the required qualification on these HITs so that only the filtered/selected workers can work on the HITs. The task protocol management 4066 helps to manage all communications to workers prior to HIT posting, during HIT posting and after HIT completion. Thus, the HIT management module 406 may be used for worker seasoning as well as for actual HIT execution by the selected crowd workers. The system environment 400 may further include a service assurance management module 408 that further includes a throughput sustenance module 408A and a quality sustenance module 4086. The throughput sustenance module 408A may further include a worker level throughput sustenance module 408A1 and a task level throughput sustenance module 408A2. Further, the quality sustenance module 4086 further include a worker level throughput sustenance module 40861 and a task level throughput sustenance module 40862. Such modules may handle the throughput and quality sustenance parameters, respectively, both at the worker and at the task levels. The system environment 400 may further include an incentive management module 410 that is common to both of the throughput sustenance module 408A and the quality sustenance module 4086 so as to incentivize workers based on throughput and quality excellence. The network 112 is common to all of the modules so that any communication to workers intended by any of the modules may be routed. The overall coordinated function of all of these modules in the service assurance system 400 helps to realize the service assurance technique described by working in conjunction with the crowdsourcing platform server 106.

The disclosed embodiments encompass numerous advantages. The disclosure provides for selecting the highly reliable crowd workers, who may work upon the one or more tasks posted or shared by the requestor. The disclosed method utilizes the one or more attributes (i.e., the requirements) provided by the requestor to select the first and second set of crowd workers from plurality of crowd workers. The disclosed method further utilizes the attributes to filter out the crowd workers, from the first set of crowd workers, who may not fit into the requirements of the requestor to process the one or more tasks. The disclosed method further selects the second set of crowd workers from the clustered first set of crowd workers. Thereafter, the disclosed method predicts the service assurance between the requestor and each of the selected second set of crowd workers based on at least performance sustenance parameters associated with the one or more tasks and the selected second set of crowd workers. The requestor may further communicate with the second set crowd workers to execute the one or more transmitted tasks.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for predicting service assurance between requestors and crowd workers for task processing on a crowdsourcing platform have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for predicting service assurance between requestors and crowd workers for task processing on a crowdsourcing platform, the method comprising:
receiving, by one or more transceivers at a computing server, one or more service level agreement (SLA) attributes of one or more tasks from a requestor-computing device associated with a requestor;
selecting, by one or more processors at the computing server, a first set of crowd workers, from a plurality of crowd workers associated with the crowdsourcing platform, based on at least a threshold value associated with each of the received one or more SLA attributes;
selecting, by the one or more processors, a second set of crowd workers, from one or more SLA-based clusters of the selected first set of crowd workers, based on one or more criteria; and
predicting, by the one or more processors, the service assurance between the requestor and each of the selected second set of crowd workers, based on at least performance sustenance parameters associated with the one or more tasks and the selected second set of crowd workers, wherein the one or more tasks are processed by the selected second set of crowd workers on the crowdsourcing platform based on the predicted service assurance.

2. The method of claim 1, wherein the crowdsourcing platform corresponds to a pull-based crowdsourcing platform, wherein a crowd worker associated with the crowdsourcing platform process a task extracted, by the crowd worker, from the crowdsourcing platform.

3. The method of claim 1 further comprising transmitting, by the one or more transceivers, a first message to the crowdsourcing platform over a communication network, wherein the first message comprises at least a task type, an expected task work, a task compensation, an expected task requirement for approval, a task incentive, an expected time of task completion, and an expected time of posting a task.

4. The method of claim 3 further comprising receiving, by the one or more transceivers, a plurality of nominations, to process the one or more tasks, from at least a plurality of crowd worker-computing devices associated with the plurality of crowd workers, wherein the plurality of crowd workers utilizes the plurality of crowd worker-computing devices to nominate based on at least the first message.

5. The method of claim 1, wherein the one or more SLA attributes of the one or more tasks comprise at least an accuracy, an execution time, and a throughput that are required to process the one or more tasks.

6. The method of claim 5, wherein the threshold value pertaining to the accuracy is defined by the requestor.

7. The method of claim 5, wherein the threshold value pertaining to the execution time is determined, by the one or more processors, based on at least a mean, a standard deviation, and a count of crowd workers in the plurality of crowd workers, wherein the mean and the standard deviation are determined based on at least historical execution time of each of the plurality of crowd workers.

8. The method of claim 5, wherein the threshold value pertaining to the throughput is determined, by the one or more processors, based on at least a mean, a standard deviation, and a count of crowd workers in the plurality of crowd workers, wherein the mean and the standard deviation are determined based on at least historical throughput of each of the plurality of crowd workers.

9. The method of claim 1 further comprising determining, by the one or more processors, an average value, pertaining to the one or more SLA attributes, for the selected first set of crowd workers based on at least a historical performance of the selected first set of crowd workers.

10. The method of claim 9, wherein the one or more SLA-based clusters of the selected first set of crowd workers are determined, by the one or more processors, based on at least the determined average value pertaining to the one or more SLA attributes.

11. The method of claim 1, wherein the service assurance are further predicted based on at least an incentive associated with the one or more tasks, a pre-defined tolerance value pertaining to a deviation in quality, and a performance discipline of each of the selected second set of crowd workers during the processing of the one or more tasks on the crowdsourcing platform.

12. The method of claim 1 further comprising transmitting, by the one or more processors, the one or more tasks, received from the requestor-computing device, to the crowdsourcing platform based on at least a first message and the predicted service assurance.

13. A system for predicting service assurance between requestors and crowd workers for task processing on a crowdsourcing platform, the system comprising:
one or more transceivers at a computing server configured to:
receive one or more service level agreement (SLA) attributes of one or more tasks from a requestor-computing device associated with a requestor;
one or more processors at the computing server configured to:
select a first set of crowd workers, from a plurality of crowd workers associated with the crowdsourcing platform, based on at least a threshold value associated with each of the received one or more SLA attributes;
select a second set of crowd workers, from one or more SLA-based clusters of the selected first set of crowd workers, based on one or more criteria; and
predict the service assurance between the requestor and each of the selected second set of crowd workers, based on at least performance sustenance parameters associated with the one or more tasks and the selected second set of crowd workers, wherein the one or more tasks are processed by the selected second set of crowd workers on the crowdsourcing platform based on the predicted service assurance.

14. The system of claim 13, wherein the crowdsourcing platform corresponds to a pull-based crowdsourcing platform, wherein a crowd worker associated with the crowdsourcing platform process a task extracted, by the crowd worker, from the crowdsourcing platform.

15. The system of claim 13, wherein the one or more transceivers are further configured to transmit a first message to the crowdsourcing platform over a communication network, wherein the first message comprises at least a task type, an expected task work, a task compensation, an expected task requirement for approval, a task incentive, an expected time of task completion, and an expected time of posting a task.

16. The system of claim 15, wherein the one or more transceivers are further configured to receive a plurality of nominations, to process the one or more tasks, from at least a plurality of crowd worker-computing devices associated with the plurality of crowd workers, wherein the plurality of crowd workers utilizes the plurality of crowd worker-computing devices to nominate based on at least the first message.

17. The system of claim 13, wherein the one or more SLA attributes of the one or more tasks comprise at least an accuracy, an execution time, and a throughput that are required to process the one or more tasks.

18. The system of claim 17, wherein the threshold value pertaining to the accuracy is defined by the requestor.

19. The system of claim 17, wherein the one or more processors are further configured to determine the threshold value pertaining to the execution time based on at least a mean, a standard deviation, and a count of crowd workers in the plurality of crowd workers, wherein the mean and the standard deviation are determined based on at least historical execution time of each of the plurality of crowd workers.

20. The system of claim 17, wherein the one or more processors are further configured to determine the threshold value pertaining to the throughput based on at least a mean, a standard deviation, and a count of crowd workers in the plurality of crowd workers, wherein the mean and the standard deviation are determined based on at least historical throughput of each of the plurality of crowd workers.

21. The system of claim 13, wherein the one or more processors are further configured to determine an average value, pertaining to the one or more SLA attributes, for the selected first set of crowd workers based on at least a historical performance of the selected first set of crowd workers.

22. The system of claim 21, wherein the one or more processors are further configured to determine the one or more SLA-based clusters of the selected first set of crowd workers based on at least the determined average value pertaining to the one or more SLA attributes.

23. The system of claim 13, wherein the service assurance are further predicted based on at least an incentive associated with the one or more tasks, a pre-defined tolerance value pertaining to a deviation in quality, and a performance discipline of each of the selected second set of crowd workers during the processing of the one or more tasks on the crowdsourcing platform.

24. The system of claim 13, wherein the one or more processors are further configured to transmit the one or more tasks, received from the requestor-computing device, to the crowdsourcing platform based on at least a first message and the predicted service assurance.

25. A computer program product for use with a computer, the computer program product comprising a non-transitory computer readable medium, wherein the non-transitory computer readable medium stores a computer program code for predicting service assurance between requestors and crowd workers for task processing on a crowdsourcing platform, wherein the computer program code is executable by one or more processors to:
receive one or more service level agreement (SLA) attributes of one or more tasks from a requestor-computing device associated with a requestor;
select a first set of crowd workers, from a plurality of crowd workers associated with the crowdsourcing platform, based on at least a threshold value associated with each of the received one or more SLA attributes;
select a second set of crowd workers, from one or more SLA-based clusters of the selected first set of crowd workers, based on one or more criteria; and
predict the service assurance between the requestor and each of the selected second set of crowd workers, based on at least performance sustenance parameters associated with the one or more tasks and the selected second set of crowd workers, wherein the one or more tasks are processed by the selected second set of crowd workers on the crowdsourcing platform based on the predicted service assurance.
